(19) United States
(12) Patent Application Publication
(10) Pub. No.: US 2003/0147330 A1
(43) Pub. Date: Aug. 7, 2003

(54) Light spot shaping device and method,light pickup device, and optical disk apparatus

(76) Inventors: Yoshiyuki Teraoka, Kanagawa (JP); Tamotsu Ishii, Chiba (JP); Goro Fujita, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/239,174

(22) PCT Filed: Jan. 25, 2002
(86) PCT No.: PCT/JP02/00569

(30) Foreign Application Priority Data
Jan. 25, 2001 (JP) 2001-17495

(51) Int. Cl. G11B 7/135; G11B 11/00

(52) U.S. Cl. 369/112.02; 369/13.09

(57) ABSTRACT

A laser beam for reproduction emitted from an LD (41) at the time of reproduction passes through an As correction board (42) and a grating (43) and becomes incident on a beam splitter (44). The beam splitter (44) transmits the laser beam and causes the laser beam to be incident on a liquid crystal unit (45). Then, at the time of reproduction, a light spot shaping device provides aberration to the laser beam transmitted through the liquid crystal unit (45) in accordance with the type of a magneto-optical disc and thus shapes a light spot on the magneto-optical disc. Therefore, optimum light spots for different media can be shaped.

### TECHNICAL FIELD

This invention relates to a light spot shaping device and method for shaping a spot of light cast onto a medium, an optical pickup device adapted to at least a plurality of types of removable optical discs having different track pitches and for forming a spot of light on an optical disc and reproducing an information signal, and an optical disc device.

### BACKGROUND ART

Optical discs having a small diameter of approximately 64 mm and having a storage capacity which enables recording of, for example, not less than 74 minutes of music signals, have been broadly known. These small-diameter optical discs are called mini disc MD (trade name, Sony Corporation). Such discs are classified into two types, that is, reproduction-only type discs on which data is recorded in the form of pits, and recording/reproduction type discs on which data is recorded by the magneto-optical (MO) recording system and can also be reproduced. The following description relates to the recording/reproduction type (herein after referred to as magneto-optical disc).

With respect to magneto-optical discs, the track pitch, the recording wavelength of a recording laser beam, or NA of an objective lens has been improved in order to increase the recording capacity.

An initial magneto-optical disc for groove recording at a track pitch of 1.6 μm and the EFM modulation system is referred to as first-format magneto-optical disc. A second-generation magneto-optical disc for land recording at a track pitch of 0.95 μm and the RLL (1, 7) modulation system is referred to as second-format magneto-optical disc. A third-generation magneto-optical disc for land and groove recording at a track pitch of 0.70 μm or less and the RLL (1, 7) modulation system is referred to as a third-format magneto-optical disc.

FIG. 17 shows the specifications of these three types of magneto-optical discs. The remarkable improvement in the recording capacity from 140 MB of the first-format magneto-optical disc to 650 MB of the second-format magneto-optical disc and to 2 GB of the third-format magneto-optical disc is due to the continuous narrowing of the track pitch as described above and the reduction in the pit length. It is also due to the development of techniques related to the respective specifications as shown in FIG. 17.

Referring to FIG. 18, which shows the address format of each magneto-optical disc, how the third-format magneto-optical disc has acquired the above-described recording capacity will now be described. FIGS. 18A, 18B and 18C illustrate the address formats of the first-format magneto-optical disc, the second-format magneto-optical disc and the third-format magneto-optical disc, respectively. The first-format magneto-optical disc has an address format which employs groove recording at a track pitch of 1.6 μm and single-spiral double-sided wobbling. The second-format magneto-optical disc has an address format which employs land recording at a track pitch of 0.95 μm and double-spiral one-sided wobbling. The third-format magneto-optical disc has an address format which employs land and groove recording at a track pitch of 0.70 μm or less and double-spiral one-sided wobbling.

Particularly in the third-format magneto-optical disc, the track pitch is narrowed to 0.70 μm or less, as described above. In the ordinary groove recording system or land recording system, the track pitch is too narrow to a spot of laser beam and therefore causes a tracking error to be small. In the third-format magneto-optical disc, however, since the land and groove recording system is employed, the groove pitch is 1.4 μm or less, which is double the track pitch, and a larger tracking error signal can be taken than in the conventional second-format magneto-optical disc. The address input method of the third-format magneto-optical disc is one-sided wobbling, similarly to the second-format magneto-optical disc, and the absolute address is encoded in this wobbling by FM modulation and biphasic modulation. The format of the address is the same as that of the second-format magneto-optical disc. What is different is that in the second-format magneto-optical disc, a groove itself is wobbled to enter address information, as shown in FIG. 18B, whereas in the third-format magneto-optical disc, only one side of a groove is wobbled and the other side is kept as DC, as shown in FIG. 18C. By employing this system, it is possible to narrow the track pitch while restraining the cross talk between adjacent wobbles.

The most outstanding feature of the third-format magneto-optical disc is data reproduction based on domain wall displacement detection (DWDD). As domain wall displacement is used, lower compatibility is maintained by having a laser wavelength of 650 mm and a lens numerical aperture of 0.52, which are the same as those of the optical system for the second-format magneto-optical disc, despite a high linear density approximately 2.6 times that of the second-format magneto-optical disc.

The third-format magneto-optical disc employs the RLL (1, 7) modulation system for recording signals, similarly to the second-format magneto-optical disc, but it uses LDC (long distance code) with BIS (burst indicator subcode) of high correction performance as an error correcting code. The minimum recording unit is 64 kilobytes. As a result of the above, a recording capacity of 2 GB can be achieved, which is approximately 3.1 times the recording capacity of 650 MB of the second-format magneto-optical disc.

Meanwhile, it is difficult to read signals recorded on the above-described magneto-optical discs of the three generations while realizing compatibility on an optical pickup device having fixed optical conditions.

On the first-format magneto-optical disc, which has a relatively wide track pitch, address information is recorded as an ADIP (address in pregroove) signal based on double-sided wobbling of the groove and therefore a somewhat large spot is necessary. As for the second-format magneto-optical disc, for which a laser beam with a short wavelength of 650 nm and an objective lens with NA of 0.52 are used, a narrow skew margin is further reduced by changing the numerical aperture of the optical pickup. With respect to the third-format magneto-optical disc, on which a signal is reproduced using the above-described DWDD, the domain wall displacement characteristic is changed by the spot shape at the time of reproduction and a spot which is small in the radial direction is suitable for improving the crosslight characteristic at the time of recording.

In this manner, there are optimum spot shapes for these discs, respectively. Therefore, it is difficult to realize compatibility on an optical pickup device having fixed optical conditions.

Moreover, in an optical disc device, as a magneto-optical signal recording/reproducing device having a reproducing unit for reproducing a signal recorded on a optical disc at a high density, for example, by the above-described DWDD, it is difficult to cast a laser beam for recording/reproduction onto the optical disc by using only one optical pickup device. Since DWDD utilizes the temperature distribution on the medium at the time of reproduction, the optimum profile for the laser beam differs between recording and reproduction and therefore its performance cannot be sufficiently exerted.

### DISCLOSURE OF THE INVENTION

In view of the foregoing status of the alt it is an object of the present invention to provide a light spot shaping device and method, an optical pickup device and an optical disc device which enable shaping of an optimum light spot to a plurality of different media.

It is another object of the present invention to provide a light spot shaping device and method, an optical pickup device and an optical disc device which enables casting of a recording and/or reproducing laser beam onto an optical disc from a single optical pickup device while changing the shape of its spot.

A light spot shaping device according to the present invention is adapted for shaping a spot of light cast onto a plurality of types of removable media from the same light source through the same optical path, in accordance with the type of the medium. The device comprises: liquid crystal means having a split pattern electrode formed along the direction of a recording track of the medium; and control means for changing a voltage to be applied to the split pattern electrode of the liquid crystal means in accordance with the type of the medium and thus changing the optical characteristic of the light spot.

In this light spot shaping device, the control means changes the voltage to be applied to the split pattern electrode of the liquid crystal means in accordance with the type of the medium, thereby providing aberration to the light at least along the direction of the track so as to shape the light spot.

A light spot shaping method according to the present invention is adapted for shaping a spot of light cast onto a plurality of types of removable media from the same light source through the same optical path, in accordance with the type of the medium. The method comprises a control step of providing liquid crystal means having a split pattern electrode formed along the direction of a recording track of the medium and changing a voltage to be applied to the split pattern electrode of the liquid crystal means in accordance with the type of the medium, thus changing the optical characteristic of the light spot.

In this light spot shaping method, at the control step, the voltage to be applied to the split pattern electrode of the liquid crystal means is changed in accordance with the type of the medium, thereby providing aberration to the light at least along the direction of the track so as to shape the light spot on the medium.

A light spot shaping device according to the present invention is adapted for separately shaping an incident laser beam in recording and in reproduction to a spot of light cast onto a medium for recording and/or reproducing an information signal. The device comprises: liquid crystal means having a split pattern electrode formed along the direction of a recording track of the medium; ad control means for changing a voltage to be applied to the split pattern electrode of the liquid crystal means between the recording and the reproduction and thus changing the optical characteristic of the light spot.

In this light spot shaping device, the control means changes the voltage to be applied to the split pattern electrode in a reproduction mode for reproducing the information signal from the medium, thus providing aberration to the light incident on the liquid crystal means along the direction of the recording track of the medium so as to shape the light spot on the medium.

A light spot shaping method according to the present invention is adapted for separately shaping an incident laser beam in recording and in reproduction to a spot of light cast onto a medium for recording and/or reproducing an information signal. The method comprises a control step of providing liquid crystal means having a split pattern electrode formed along the direction of a recording track of the medium and changing a voltage to be applied to the split pattern electrode of the liquid crystal means between the recording and the reproduction, thus changing the optical characteristic of the light spot.

In this light spot shaping method, at the control step, the voltage to be applied to the split pattern electrode is changed in a reproduction mode for reproducing the information signal from the medium, thus providing aberration to the light incident on the liquid crystal means along the direction of the recording track of the medium so as to shape the light spot on the medium.

An optical pickup device according to the present invention is adapted for forming a spot of light adapted to a plurality of types of removable optical discs having at least different track pitches, onto the optical disc, thus reading an information signal. The device comprises: a light source for emitting light; an optical system for casting the light emitted from the light source onto a signal recording surface of the optical disc and passing return light reflected by the signal recording surface of the optical disc; photodetection means for detecting the return light passed by the optical system; liquid crystal means provided in the optical system and having a split pattern electrode stacked in a radial direction of the optical disc; and light spot shaping means for changing a voltage to be applied to the split pattern electrode of the liquid crystal means for each type of the optical disc and thus changing the optical characteristic of the light spot.

In this optical pickup device, the light spot shaping means changes the voltage to be applied to the split pattern electrode of the liquid crystal means in accordance with the type of the optical disc, thus providing aberration to the light at least along the radial direction so as to shape the light spot.

An optical pickup device according to the present invention is adapted for casting recording light and/or reproducing light for recording and/or reproducing an information signal to an optical disc. The device comprises: a light source for emitting light; an optical system for casting the light emitted from the light source onto a signal recording surface of the optical disc and passing return light reflected by the signal recording surface of the optical disc; photodetection means for detecting the return light passed by the optical system; liquid crystal means provided in the optical system and having a split pattern electrode stacked in a radial direction of the optical disc; and light spot shaping means for changing the optical characteristic of the light spot between when casting the recording light and when casting the reproducing light.

In this optical pickup device, the light spot shaping means changes the voltage to be applied to the split pattern electrode of the liquid crystal means in a reproduction mode for reproducing the information signal from the optical disc, thus providing aberration to the light incident on the liquid crystal means along a tangential direction of a track of the optical disc so as to shape the light spot on the optical disc.

An optical disc device according to the present invention having a reproducing part for forming a spot of light adapted to a plurality of types of removable optical discs having at least different track pitches, onto the optical disc, thus reading an information signal from each optical disc. In the optical disc device, the reproducing part comprises: a light source for emitting light; an optical system for casting the light emitted from the light source onto a signal recording surface of the optical disc and passing return light reflected by the signal recording surface of the optical disc; photodetection means for detecting the return light passed by the optical system; liquid crystal means provided in the optical system and having a split pattern electrode stacked in a radial direction of the optical disc; and light spot shaping means for changing a voltage to be applied to the split pattern electrode of the liquid crystal means in accordance with the type of the optical disc and thus changing the optical characteristic of the light spot so as to shape the light spot. In the optical disc device, the information signal is reproduced on the basis of the quantity of the return light detected by the photodetection means.

In this optical disc device, the light spot shaping means changes the voltage to be applied to the split pattern electrode of the liquid crystal means in accordance with the type of the optical disc, thus providing aberration to the light at least along the radial direction so as to shape the light spot on the optical disc.

An optical disc device according to the present invention is adapted for casting recording light and/or reproducing light to an optical disc so as to record and/or reproduce an information signal. The device comprises: a light source for emitting light; an optical system for casting the light emitted from the light source onto a signal recording surface of the optical disc and passing return light reflected by the signal recording surface of the optical disc; photodetection means for detecting the return light passed by the optical system; liquid crystal means provided in the optical system and having a split pattern electrode stacked in a radial direction of the optical disc; and light spot shaping means for changing the optical characteristic of the light spot between when casting the recording light and when casting the reproducing light.

In this optical disc device, the light spot shaping means changes the voltage to be applied to the split pattern electrode of the liquid crystal means in a reproduction mode for reproducing the information signal from the optical disc, thus providing aberration to the light incident on the liquid crystal means along a tangential direction of a track of the optical disc so as to shape the light spot on the optical disc.

The other objects and advantages of the present invention will be further clarified by the following description of embodiments.

### BRIEF DESCRIPTION OF THE DRAWINGS

FIG. 1 is a block diagram showing the structure of a magneto-optical disc recording/reproducing device as a first embodiment.

FIG. 2 shows the structure of an optical pickup device provided in the magneto-optical disc recording/reproducing device shown in FIG. 1.

FIG. 3 shows a split pattern electrode of a liquid crystal part of a light spot shaping device provided in the magneto-optical disc recording/reproducing device shown in FIG. 1.

FIG. 4 is a graph showing light intensity distribution on a second-format magneto-optical disc when the disc is inclined 0.7 degrees (radial skew).

FIG. 5 schematically illustrates spot shaping carried out by the light spot shaping device shown iii FIG. 3.

FIG. 6 shows an applied voltage for acquiring a light spot for a third-format magneto-optical disc by shaping from a light spot for the second-format magneto-optical disc with no liquid crystal correction.

FIG. 7 shows an applied voltage for providing a beam with an aberration pattern close to coma in the case of reproducing a signal from the second-format magneto-optical disc.

FIG. 8 shows a change characteristic of a spot size by providing a light spot with a defocus in a linear direction.

FIG. 9 is a block diagram showing the structure of a video camera recording/reproducing device to which the magneto-optical disc recording/reproducing device shown in FIG. 1 is applied.

FIG. 10 is a block diagram showing the structure of a magneto-optical disc recording/reproducing device as a second embodiment.

FIG. 11 schematically illustrate domain wall displacement detection.

FIG. 12 is a graph for explaining the operation of the magneto-optical disc recording/reproducing device shown in FIG. 10.

FIG. 13 illustrates a ghost generated by domain wall displacement detection.

FIG. 14 shows an actual temperature profile of a spot on a magneto-optical disc due to casting of a light beam.

FIG. 15 shows a ghost signal generated together with a data signal when reproducing a recorded signal from a magneto-optical disc (DWDD).

FIG. 16 shows elimination of a ghost signal when reproducing a recorded signal from a magneto-optical disc (DWDD).

FIG. 17 shows the specifications of three types of magneto-optical discs.

FIG. 18 shows address formats of the respective magneto-optical discs so as to explain how a third-format magneto-optical disc has acquired its recording capacity.

### BEST MODE FOR CARRYING OUT THE INVENTION

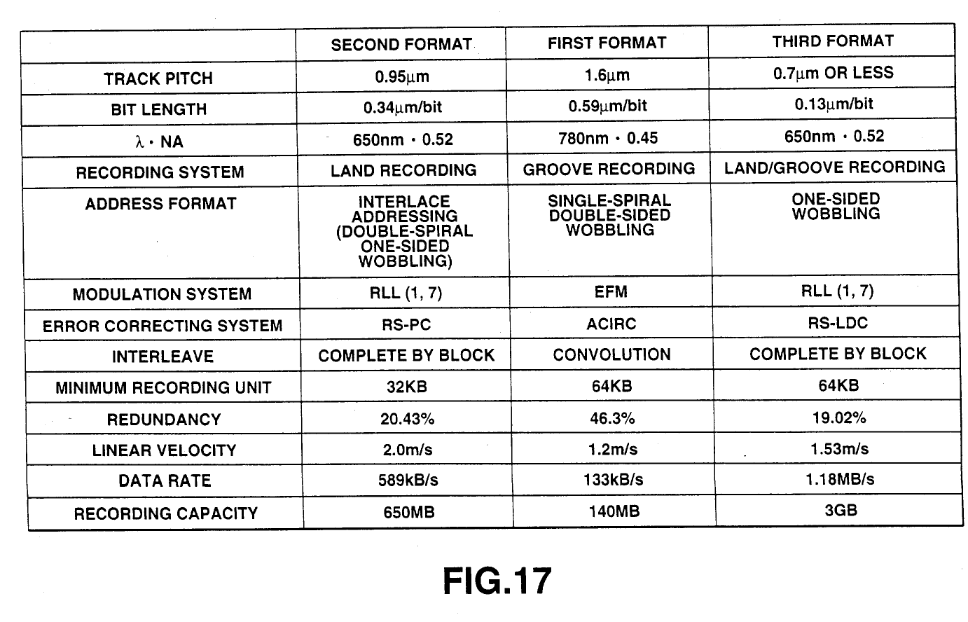

Hereinafter, embodiments of the present invention will be described with reference to the drawings. A first embodiment will be described first. This first embodiment is a magneto-optical disc recording/reproducing device which has a reproducing unit for forming a light spot adapted to each of three types of magneto-optical discs having at least different track pitches, that is, the first-format magneto-optical disc, the second-format magneto-optical disc and the third-format magneto-optical disc shown in FIG. 17, and reproducing an information signal from each magneto-optical disc, and a recording unit for recording an information signal to each magneto-optical disc.

This magneto-optical disc recording/reproducing device has an optical pickup device tot which a specific example of the light spot shaping device of the present invention is applied. The optical pickup device will be later described in detail.

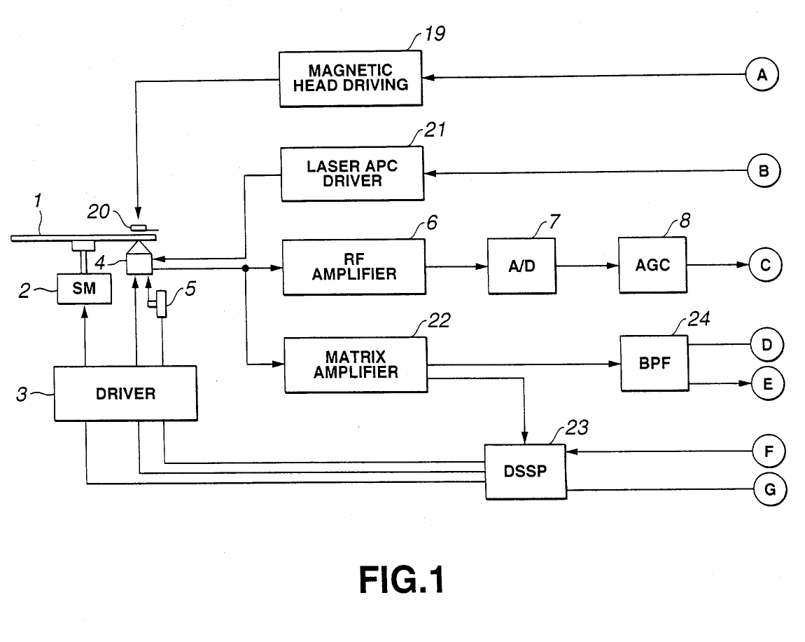

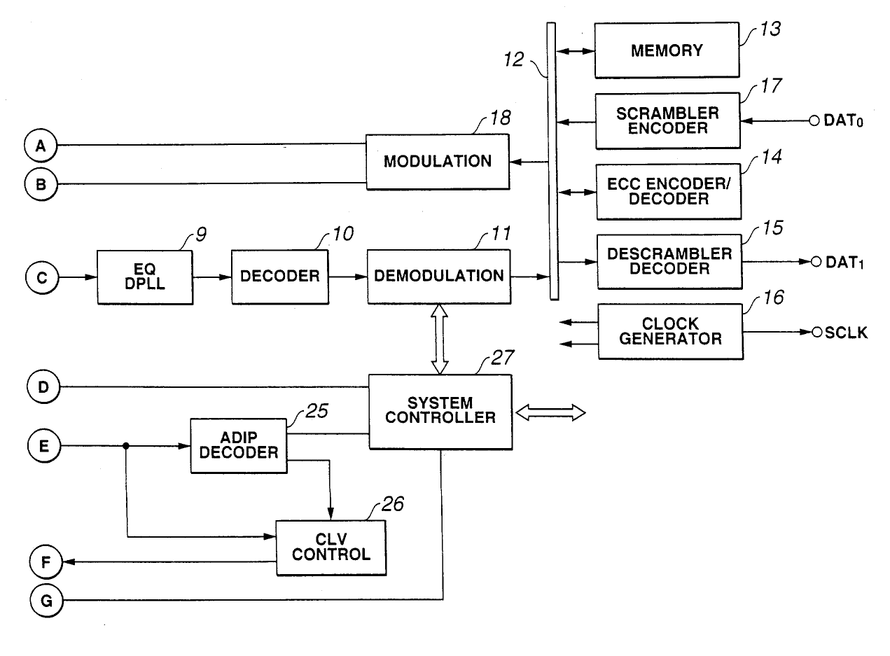

First, referring to FIG. 1, a structure for rotating one magneto-optical disc 1 of the three types of magneto-optical discs loaded on the magneto-optical disc recording/reproducing device, and a structure for moving an optical pickup device 4 over the magneto-optical disc 1 will be described. The magneto-optical disc 1 is rotated at a predetermined number of rotations by a spindle motor 2. The spindle motor 2 is driven by a driver 3. The driver 3 is controlled by a digital servo processor (DSSP) 23, which will be described later, thus rotating the spindle motor 2.

The magneto-optical disc 1 rotated by the spindle motor 2 is irradiated with a laser beam from the optical pickup device 4. Data on the magneto-optical disc 1 is read by moving the optical pickup device 4 in a radial direction of the magneto-optical disc 1. The optical pickup device 4 is supported by a thread mechanism having a thread motor 5 and is thus made movable in the radial direction of the magneto-optical disc 1. A large shift of the reading position is made by this thread mechanism. As all objective lens, which will be described later, of the optical pickup device 4 is supported by a biaxial driving circuit and is moved in the radial direction of the magneto-optical disc 1 by the driver 3 on the basis of a tracking servo operation, a small shift of the reading position is made. Moreover, as the objective lens is moved in directions toward and away from the magneto-optical disc 1 by the biaxial driving circuit on the basis of a focusing servo operation, the focusing of the laser beam on the signal recording surface of the magneto-optical disc 1 is controlled.

The structure of the reproducing unit will now be described. The optical pickup device 4 generates an RF signal and supplies the RF signal to an RF amplifier 6. The signal amplified with a predetermined gain by the RF amplifier 6 is sequentially supplied to an A/D converter 7, an automatic gain control (AGC) circuit 8; an equalizer (EQ) and digital PLL unit 9, a decoder 10 and a demodulator 11, which form a signal processing unit. The demodulator 11 is connected to a memory unit 13, an ECC encoder/decoder 14 and a descrambler and decoder 15 via an internal bus 12.

This reproducing unit operates as follows. Specifically, a signal picked up from the magneto-optical disc 1 by the optical pickup device 4 is photoelectrically converted in the optical pickup device 4 and the outputted as an RF signal. This RF signal is inputted to the RF amplifier 6, amplified there with a predetermined gain and then supplied to the A/D converter 7 constituting the signal processing unit. The RF signal supplied to the A/D converter 7 is quantized. After that, the gain is controlled by the AGC processing unit 8, and then waveform shaping and generation of a sampling clock are carried out by the equalizer (EQ) and digital PLL unit 9. The resulting signal is decoded by the decoder 10 and then demodulated by the demodulator 11. While AGC, equalization and DPLL are performed on the A/D-converted RF sisal in this case, analog AGC, equalization and PLL may be performed on the signal before A/D conversion. The data stream demodulated by the demodulator 11 is expanded on the memory 13 and each error connecting block thereof is error-connected by the ECC encoder/decoder 14. Descrambling processing and decoding processing are performed on the error-corrected data by the descrambler and decoder 15, and a DAT1 signal is outputted togther with a transfer clock SCLK from a clock generator 16.

The structure of the recording unit will now be described. An inputted signal DAT0 is processed by a scrambler and encoder 17 and then sequentially supplied to the memory unit 13, the ECC encoder/decoder 14 and a modulator 18 via the internal bus 12. The modulator 18 supplies modulated data to a magnetic head driving unit 19. The magnetic head driving unit 19 drives a magnetic head 20. The modulator 18 also supplies a clock signal to a laser APC circuit and driver 21.

The recording unit operates as follows. Specifically, scrambling processing and encoding processing by the scrambler and encoder 17 are performed oil a signal DAT0 inputted synchronously with a transfer clock SCLK, which is then written into the memory unit 13. An error connecting parity is added to the data written in the memory unit 13 by the ECC encoder/decoder 14 and the resulting data is supplied to the modulator 18 via the internal bus 12. The data modulated by the modulator 18 is supplied to the magnetic head 20 via the magnetic head driving unit 19. Meanwhile, a laser strobe modulation clock is supplied to the laser APC circuit and driver 21 from the modulator 18.

The structure of a servo system will now be described. This servo system has the following elements: a matrix amplifier 22 for extracting a servo en-or signal and a wobble signal, which will be described later, from a signal generated by the optical pickup device 4; a DSSP 23 for performing predetermined servo processing on the thread mechanism and the actuator of the optical pickup device 4 via the driver 3 on the basis of the servo error signal and for performing spindle servo processing on the spindle motor (SM) 2 in accordance with a CLV control signal, which will be described later; and a system controller 27 for controlling the DSSP 23. The servo system also has a band pass filter (BPF) 24 for detecting an ADIP (address in pregroove) signal from the wobble signal extracted by the matrix amplifier, an ADIP decoder 25 for decoding the ADIP signal, and a CLV control unit 26 for supplying a CLV control signal to the DSSP 23.

The operation of the servo system will now be described. Phase compensation, and gain and target value setting processing by the DSSP 23 are performed on a servo error signal extracted by the matrix amplifier 22 from a signal from the optical pickup device 4, and the resulting signal is supplied to the actuator in the optical pickup device 4 and the thread motor 5 via the driver 3. Since a tracking error signal has opposite polarities at a land part and a groove part of the magneto-optical disc, the system controller 27 switches the polarity, depending on which part is to be recorded/reproduced. Particularly, it is known that when an astigmatic method is used for focus detection on the land/groove disc, an offset between a land pall and a groove part is generated. To eliminate its influence, the system controller 27 sets a focusing offset separately at the land pail and at the groove part.

Meanwhile, a wobble signal outputted from the matrix amplifier 22 has its component extracted by the band pass filter (BPF) 24, and address information decoded by the ADIP decoder 25 is transferred to the system controller 27. All integral of the output of the BPF 24 and the PLL phase error in the ADIP decoder 25, and a control signal from the system controller 27 are supplied to the CLV control unit 26 and are supplied to the spindle motor 2 via the DSSP 23 and the driver 3.

The magneto-optical disc recording/reproducing device shown in FIG. 1 is adapted for recording and reproducing information signals to and from the first-format magneto-optical disc, the second-format magneto-optical disc and the third-format magneto-optical disc which have different specifications from one another. Therefore, the optical pickup device 4 or the recording unit and the reproducing unit can be adapted to any of these discs.

The discrimination of the three types of discs is carried out by reading all identification mark provided on a cartridge, since all of these discs are housed in cartridges. The disc type may also be discriminated by detecting the difference in format itself.

First, shaping of a light spot adapted to the three types of magneto-optical discs in the optical pickup device 4 as an essential part of the present invention will be described.

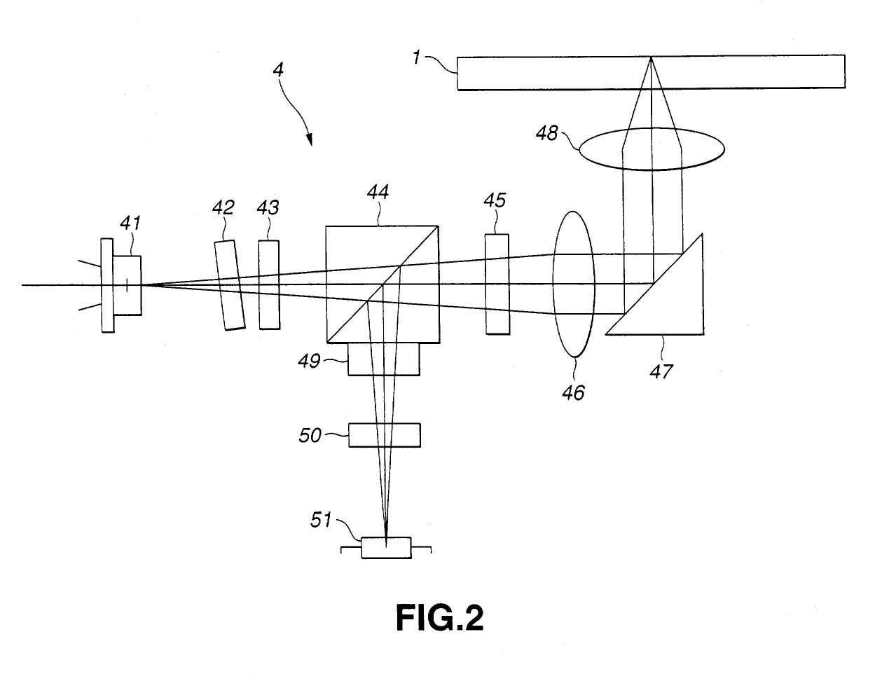

FIG. 2 shows the detailed structure of the optical pickup device 4. Specifically, this optical pickup device 4 has a laser diode (LD) 41 as a light source for emitting a laser beam, an irradiation path for irradiating the signal recording surface of the magneto-optical disc 1 with the laser beam emitted from the LD 41, an optical system for forming a return light path which passes return light reflected by the signal recording surface of the magneto-optical disc, and a photodetector (PD) 51 for detecting the quantity of return light lead by the return light path of the optical system. The optical system includes an As correction board 42, a grating 43, a beam splitter 44, a collimating lens 46, a mirror 47, an objective lens 48, a Wollaston prism 49, and a multi-lens 50. The optical pickup device 4 also has a liquid crystal unit 45 of a light spot shaping device as a specific example of the light spot shaping device of the present invention, between the beam splitter 44 and the collimating lens 46 of the optical system.

This light spot shaping device, at the time of reproduction, changes a voltage to be applied to a split pattern electrode of the liquid crystal unit 45 by a control unit in accordance with the type of the magneto-optical disc 1, thereby changing the optical characteristic of the light spot so as to shape the light spot.

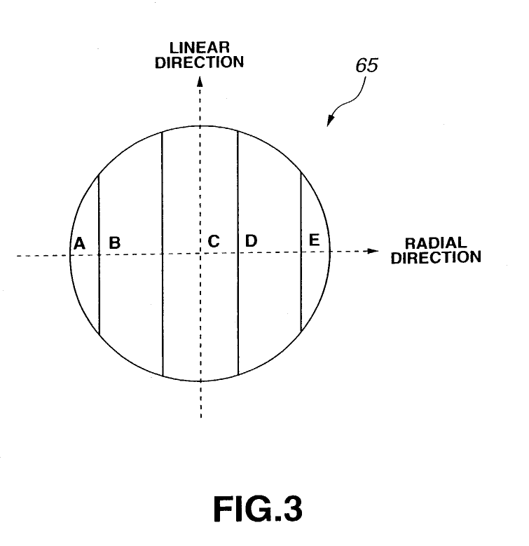

In the following description, it is assumed that the optical pickup device 4 is designed for the second-format magneto-optical disc, for example. In the optical pickup device 4, a reproducing laser beam emitted from the LD 41 at the time of reproduction passes through the As correction board 42 and the grating 43 and becomes incident on the beam splitter 44. The beam splitter 44 passes the laser beam and causes the laser beam to be incident on the liquid crystal unit 45. At the time of reproduction, the light spot shaping device provides aberration to the laser beam passing through the liquid crystal unit 45 in accordance with the type of the magneto-optical disc and thus shapes the light spot on the magneto-optical disc. As will be later described in detail, by changing a voltage to be applied to split pattern electrodes A, B, C, D and E of the liquid crystal unit 45 as shown in FIG. 3, the laser beam is provided with aberration and the light spot on the magneto-optical disc is shaped in a radial direction or in a linear direction. The laser beam shaped in accordance with each magneto-optical disc by the liquid crystal unit 45 of the light spot shaping device is collimated by the collimating lens 46 and reflected by the mirror 47. After that, the laser beam is condensed by the objective lens 48 and cast onto the signal recording surface of the magneto-optical disc 1.

Return light reflected by the signal recording surface of the magneto-optical disc 1 passes through the objective lens 48, the mirror 47, the collimating lens 46 and the liquid crystal unit 45, and then reflected to the direction of the PD 51 by the beam splitter 44. The return light is then split by the Wollaston prism 49, condensed by the multi-lens 50 and made incident on a light receiving surface oil the PD 51.

On the PD 51, a plurality of quadrisected light receiving surfaces each having a quadrisected light receiving area, for example, two quadrisected light receiving surfaces are provided, and a received light quantity signal (RF signal) detected by the PD 51 is supplied to the RF amplifier 6 shown in FIG. 1.

The liquid crystal unit 45 of the light spot shaping device is formed in a circular or elliptical shape having the split pattern electrodes A, B, C, D and E as shown ill FIG. 3 along the radial direction of the magneto-optical disc 1. For example, with the center of the circle assumed as 0, the pattern electrodes A, B, C, D and E have the following widths in the radial direction: A=−1.0 to −0.85; B=−0.85 to −0.13; C=−0.13 to +0.13; D=+0.13 to +0.85; and E=+0.85 to +1.00.

Since the optical pickup device 4 is designed for the second-format magneto-optical disc as described above, the wavelength λ of the laser beam is 650 nm and the numerical aperture NA of the objective lens 48 is 0.52, as shown in FIG. 17.

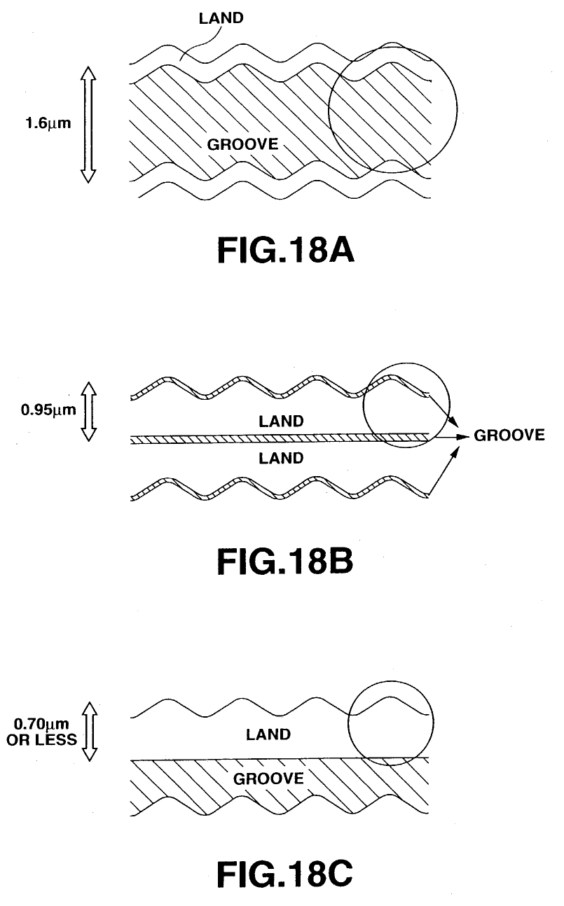

In the case of reproducing data from the first-format magneto-optical disc by using such an optical pickup device 4, the spot for the second-format magneto-optical disc, which is small in the radial direction, must be increased by defocusing to a certain extent in order to read ADIP, because address information is recorded on the first-format magneto-optical disc by using an ADIP signal based oil double-sided wobbling of the groove as described with reference to FIG. 18. However, too much defocusing reaches the end of an S shape of focus lead-in and consequently no defocusing margin can be taken. To overcome this, the light spot shaping device provides aberration to the spot for the second-format magneto-optical disc and carries out spot shaping so that the spot is laterally elongated in the radial direction.

In the case of reproducing data from the third-format magneto-optical disc by using the optical pickup device 4, since a recorded signal via a domain wall enlarged in the linear direction is detected on the third-format magneto-optical disc by DWDD, a vertically long spot in the linear direction increases the light quantity contributing to the reproduction. Therefore, the reproduction characteristic is unproved and the crosslight characteristic in recording is improved. Thus, the light spot shaping device provides aberration to the spot for the second-format magneto-optical disc and carries out spot shaping so that the spot is vertically elongated in the linear direction. Moreover, defocusing is carried out as will be described later.

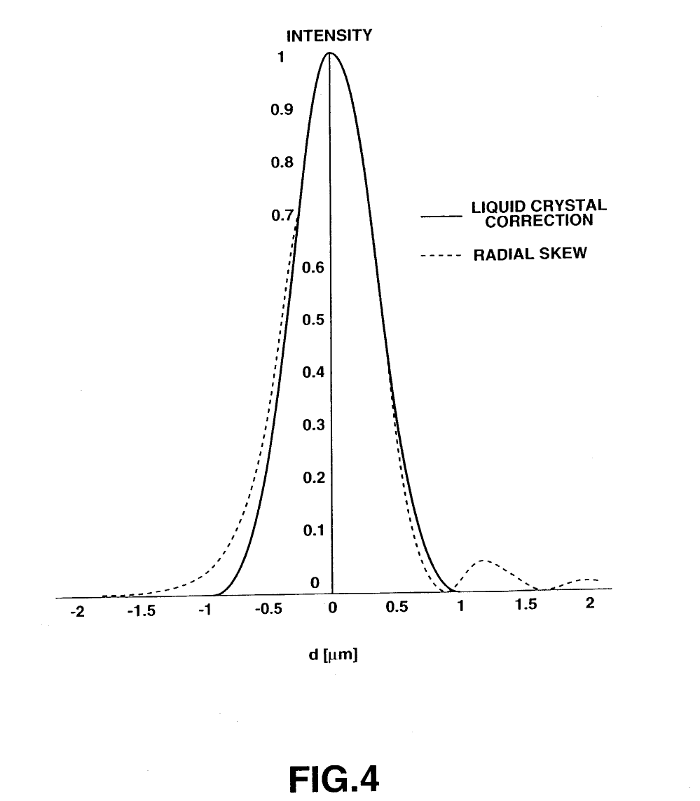

In the case of reproducing data from the second-format magneto-optical disc, as an aberration pattern close to coma is provided to the beam by the light spot shaping device and coma correction based on the skew is carried out in order to enlarge a radial skew margin the reproduction characteristic can be improved. For example, a light intensity distribution characteristic on the disc when the second-format magneto-optical disc is inclined 0.7 degrees (radial skew) is shown by a broken line in FIG. 4. If the intensity at the center of the spot is 1, the intensity is once lowered to 0 around a position away from the center by +0.7 μm and then raised to an intensity peak of 0.05 at a position of +1 μm to form a convex shape. The light intensity distribution characteristic shown by the broken line exhibits a spread bottom as a whole. Therefore, according to the light intensity distribution characteristic shown by the broken line, it is known that an adjacent track may be read because of the radial skew of 0.7 degrees. Thus, the light spot shaping device carries out liquid crystal correction so as to eliminate the convex shape having the intensity peak of 0.05 and to prevent the spreading of the bottom on both sides. In FIG. 4, the light intensity distribution characteristic after the liquid crystal correction by the light spot shaping device is shown by a solid line. According to the light intensity distribution characteristic of this solid line, since any deviation of the light spot from the lateral track is eliminated, the reproduction characteristic can be improved.

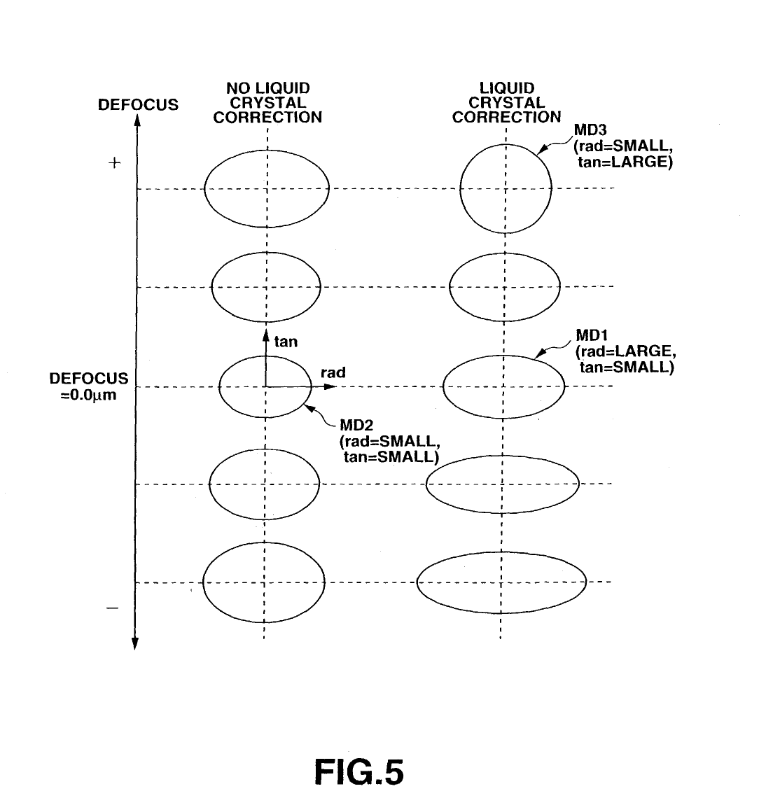

Referring to FIGS. 5 to 8, the operation of the light spot shaping device to shape a light spot for the second-format magneto-optical disc in accordance with the three types of magneto-optical discs by light spot shaping using the liquid crystal unit 45 will now be described.

FIG. 5 is a view for schematically showing spot shaping.

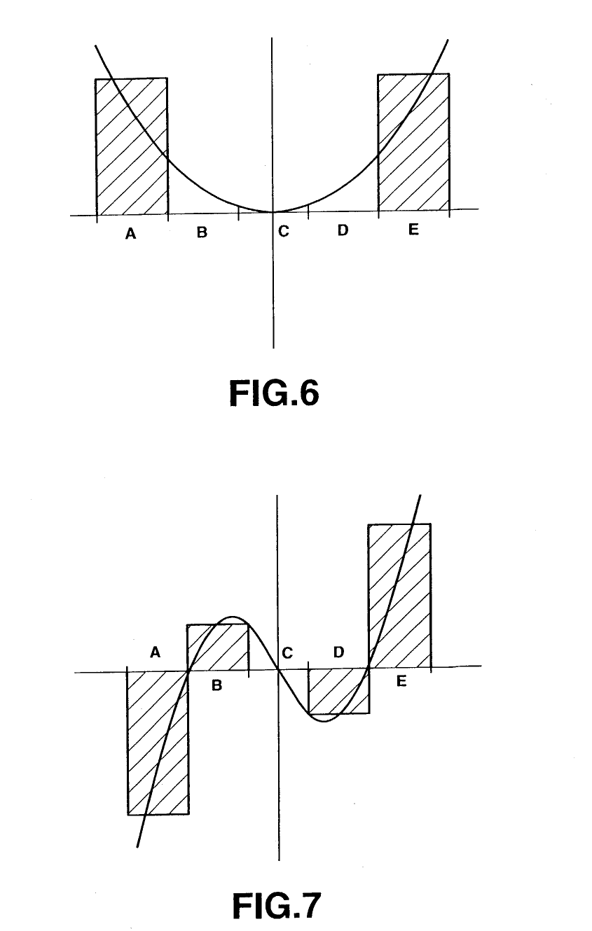

First, the operation of the light spot shaping device to shape a light spot for the first-format magneto-optical disc from a light spot for the second-format magneto-optical disc with no liquid crystal correction will be described. In this case, the light spot shaping device supplies an applied voltage as shown in FIG. 6 to the split electrode pattern parts A and E of the liquid crystal unit 45 shown in FIG. 3 and provides an aberration pattern close to astigmatism to a beam. Thus, a spot which is elongate in a radial direction (rad) can be shaped.

Although not shown in FIG. 5, the operation to provide an aberration pattern close to coma to a beam and carry out coma correction based on skew in the case of reproducing data from the second-format magneto-optical disc will be described. In the light spot shaping device, voltages of different magnitudes in one direction (A>D) are applied to the split electrode pattern parts A and D of the liquid crystal unit 45 and voltages of different magnitudes in the other direction (E>B) are applied to the pairs B and E, as shown in FIG. 7. Thus, an aberration pattern close to coma is provided to a beam and coma correction based on skew is carried out to enlarge a radial skew margin.

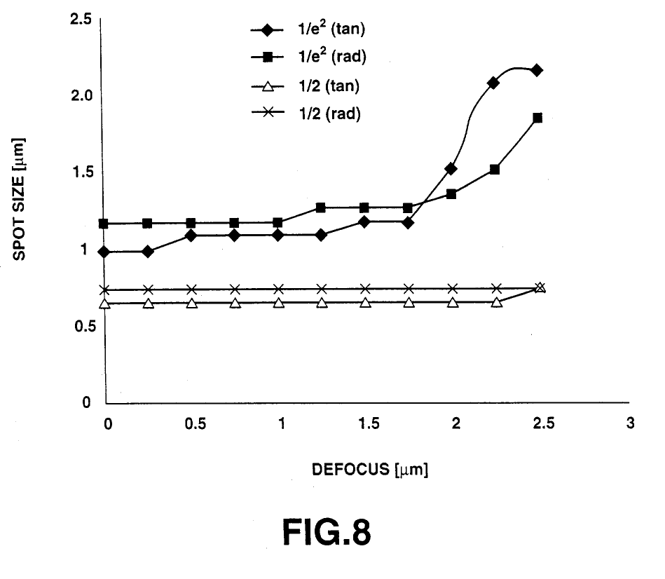

The operation of the light spot shaping device to acquire, by shaping, a light spot for the third-format magneto-optical disc from a light spot from the second-format magneto-optical disc with no liquid crystal correction will now be described. In this case, the light spot shaping device supplies an applied voltage as shown in FIG. 6 to the split electrode pattern parts A and E of the liquid crystal unit 45 shown in FIG. 3, then provides an aberration pattern close to astigmatism to a beam, and provides a defocus in a tangential direction (tan), thus shaping a spot which is elongate in the tangential direction. FIG. 8 shows a change characteristic of a spot size by providing a defocus in the tangential direction to a light spot. The light intensity 1/e² and ½ used for defining the spot size on the disc are used as parameters in the tangential direction (tan) and the radial direction (rad), respectively. It is understood that when the light intensity is 1/e², the defocus becomes close to 2 μm and that the spot size rapidly increases as the defocus exceeds 2 μm. Therefore, by providing a defocus of approximately 2 μm to the light for the second-format magneto-optical disc, a light spot for the third-format magneto-optical disc which is elongate in the tangential direction can be shaped.

As described above, in the magneto-optical disc recording/reproducing device shown in FIG. 1, at the time of reproduction, an optimum spot for each disc can be shaped simply by changing an applied voltage pattern to be applied to the liquid crystal unit 45 in accordance with each of the three types of magneto-optical discs by the light spot shaping device in the optical pickup device 4. Therefore, the compatibility can be secured inexpensively and with a simple structure.

As described above, in this magneto-optical disc recording/reproducing device, the recording unit and the reproducing unit as well as the optical pickup device 4 can be adapted to recording to and reproduction from the three types of magneto-optical discs.

First, in the recording unit, the ECC encoder/decoder 14 adds an error correcting code to data written in the memory 13. In this case, ACIRC (advanced cross interleave Reed-Solomon code) processing is performed on data for the first-format magneto-optical disc. RS-PC (Reed-Solomon parallel code) processing is performed on data for the second-format magneto-optical disc. RS-LDC (Reed-Solomon long distance code) processing performed on data for the third-format magneto-optical disc.

The modulator 18 performs modulation processing corresponding to each type of disc on the data on which the above-described respective ECC processing has been performed by the ECC encoder/decoder 14. EFM processing is performed on the data for the first-format magneto-optical disc. RLL (1, 7) processing is performed on the data for the second-format magneto-optical disc and the third-format magneto-optical disc.

Moreover, in the recording unit, the interleave, minimum recording unit, redundancy, address format and the like are switched in accordance with the thhree types of discs as shown in FIG. 17, thus generating recording data.

Similarly, in the reproducing unit, the decoding processing by the decoder 10, the demodulation processing by the demodulator 11, the ECC processing by the ECC encoder/decoder 14 and the like are switched in accordance with the three types of discs.

For example, the reproducing operation when reproducing data from the third-format magneto-optical disc will be described. A signal picked up from the magneto-optical disc 1 is photoelectrically converted in the optical pickup device 4, then enters the RF amplifier 6, and integrated so as to eliminate the fluctuation of a low-frequency component proper to the above-described DWDD. The signal is passed through the LPF for noise reduction and then quantized by the A/D converter 7. After that, AGC processing and equalization processing are performed and a sampling clock is generated by PLL. Decoding processing based on completion by block is performed by the decoder 10 and the RLL (1, 7) signal is demodulated by the demodulator 11. The data stream expanded on the memory unit 13 is processed with RS-LDC processing for each error connecting block by the ECC encoder/decoder 14 and is also processed with descrambling processing and decoding processing by the descrambler and decoder 15, thus being outputted as a DAT1 signal.

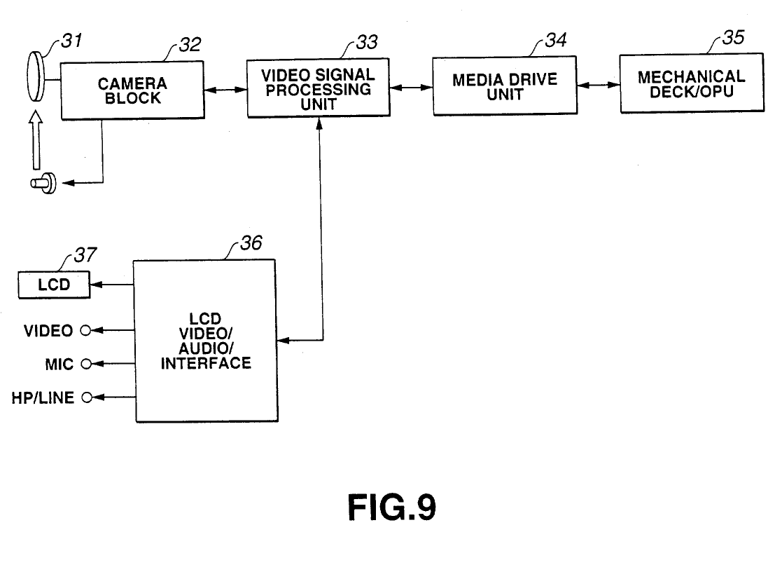

The above-described magneto-optical disc recording/reproducing device is applied to a media drive unit 34 and mechanical deck/OPU (optical pickup unit) 35 of a video camera recording/reproducing device having a structure shown in FIG. 9. In FIG. 9, an image signal supplied via a camera block 32 from a lens 31 is processed with image processing such as motion compensation by a video signal processing unit 33 and then becomes an MPEG2 data stream. A signal having an OSD signal or the like added thereto is supplied to an LCD/video/audio/interface block 36 and is then monitored on an LCD display 37. The coded MPEG2 data is sent to the media drive 34 and processed as described above as in the magneto-optical disc recording/reproducing device. After that, the processed data is supplied to the mechanical deck/OPU 35 and written to a disc. In reproduction, when the disc loaded on the mechanical deck/OPU 35 is one of the three types of discs, the light spot shaping device provided in the OPU shapes a light spot corresponding to the disc type and casts the light spot onto the signal recording surface of the disc. The light spot shaping device can shape an optimum spot for each disc simply by changing an applied voltage pattern to be applied to the liquid crystal unit. Therefore, the compatibility can be secured inexpensively and with a simple structure.

A magneto-optical disc recording/reproducing device as a second embodiment of the present invention will now be described. This second embodiment includes an optical pickup device having another specific example of the light spot shaping device which has the liquid crystal unit having the split pattern electrode shown in FIG. 3 and the control unit for changing a voltage to be applied to the split pattern electrode and thus changing the optical characteristic of a light spot so as to shape the light spot.

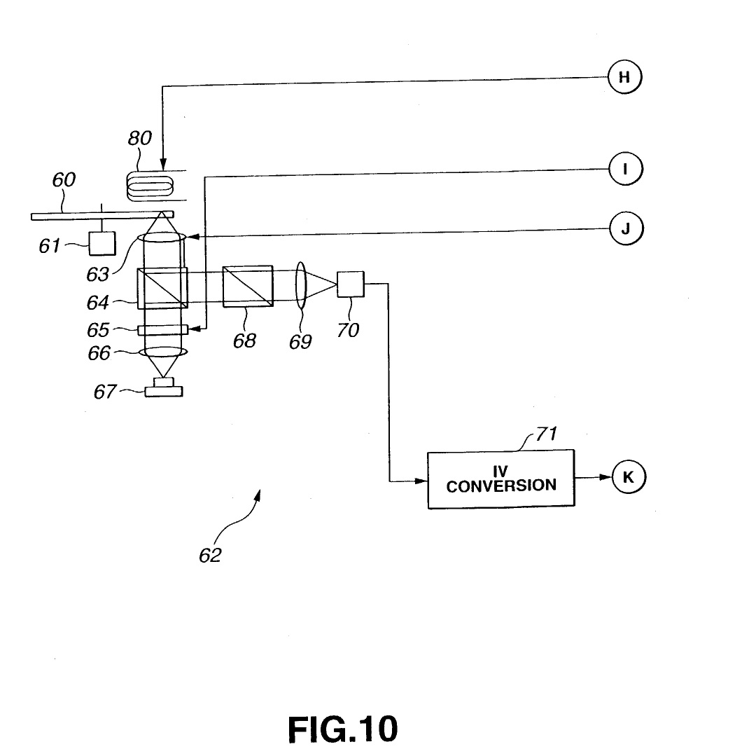

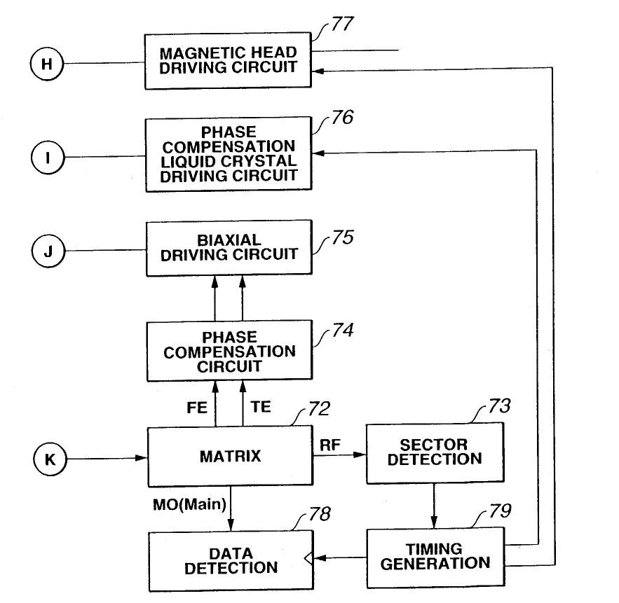

The magneto-optical disc recording/reproducing device of the second embodiment is adapted for casing recording/reproducing light to a magneto-optical disc 60 by an optical pickup device 62, thus recording/reproducing an information signal, as shown in FIG. 10.

This magneto-optical disc recording/reproducing device has the following elements: an LD 67 provided inside the optical pickup device 62 and adapted for emitting a laser beam; an optical system similarly provided inside the optical pickup device 62 and adapted for casting the laser beam emitted from the LD 67 to a signal recording surface of the magneto-optical disc 60 and passing return light reflected from the magneto-optical disc 60; a PD 70 for detecting the return light led by the optical system; and a light spot shaping device for changing the optical characteristic of the light spot between when passing the recording light and when passing the reproducing light.

The optical system is provided in the optical pickup device 62 and forms an irradiation path for irradiating the signal recording surface of the magneto-optical disc 60 with the laser beam emitted from the LD 67 and a return light path for passing the return light reflected fi-on the magneto-optical disc 60.

The light spot shaping device has a liquid crystal unit 65 provided in the irradiation path of the optical system and having a split pattern electrode along a radial direction of the optical disc, and a phase compensation liquid crystal driving circuit 76 for controlling phase compensation in the liquid crystal unit 65. The details of the structure of the magneto-optical disc recording/reproducing device, including the other parts of the structure, will be described later.

The magneto-optical disc recording/reproducing device reproduces, by the above-described domain wall displacement detection, data from the magneto-optical disc (MO disc) 60 on which the data is recorded at a high density. First, the principle of the domain wall displacement detection will be described. The domain wall displacement detection enables reproduction of data from a magneto-optical disc on which the data is recorded at a high density, in order to realize high-density recording and reproduction on a magneto-optical disc (MO) as a recording medium on which rewriting of an information signal is possible. This domain wall displacement detection is a technique of carrying out magnetic domain enlargement and reading a mark which is smaller than a light spot in reproduction, by using thermal distribution induced by the light spot. Since the domain wall displacement detection enables complete detection of the edge of the mark, it is suitable for reproduction of data from a magneto-optical disc which employs so-called “mark edge recording”.

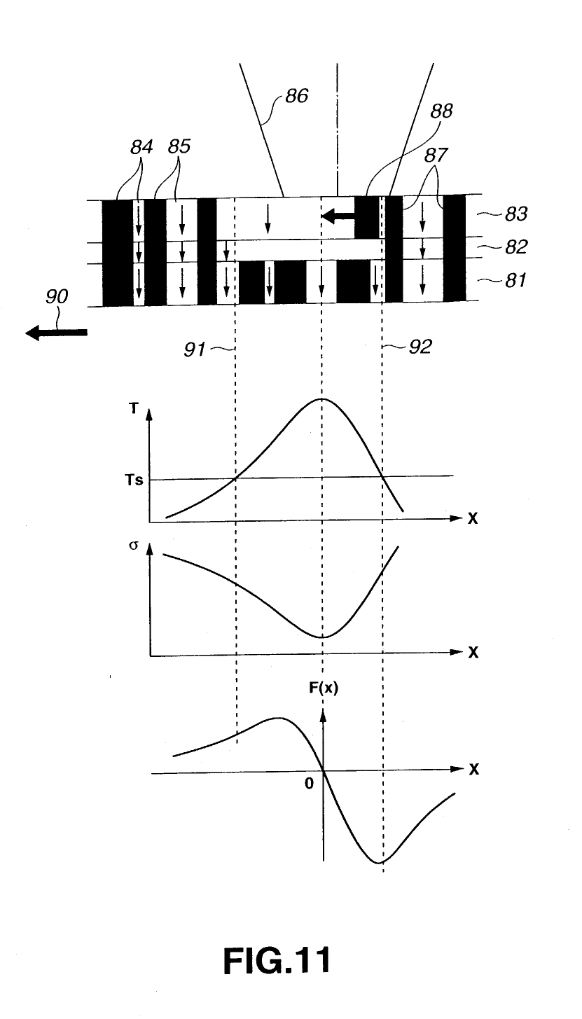

A magneto-optical disc for carrying out the domain wall displacement detection has an enlargement layer 83 and a recording layer 81, and also has a switching layer 82 between the enlargement layer 82 and the recording layer 81, as shown in FIG. 11. The principle of reproduction based on the domain wall displacement detection is to detect the presence of a mark by utilizing quick displacement (domain wall displacement 88) of a domain wall 87 of the enlargement layer 83 to a highest temperature portion when the domain wall 87 comes to a front end 92 of an isothermal area of not lower than the Curie temperature induced by a laser beam 86, as shown in FIG. 11.

The basic principle of the operation of the second embodiment in the case where the present invention is applied to a DWDD disc will now be described. FIG. 11 shows the characteristic of temperature distribution T with respect to the position x of a laser spot, and the characteristic of energy density a of the domain wall with respect to the position x of the laser spot. Moreover, FIG. 11 shows the characteristic of driving force F(x) of the domain wall displacement with respect to the position x of the laser spot.

In the DWDD disc, the driving force F(x) of the domain wall displacement at the front end part 92, which contributes to reproduction, is proportional to the slope of temperature distribution in a beam traveling direction indicated by an arrow 90. That is, the driving force F(x) of the domain wall displacement is expressed by

F(x)=−∂σ/∂x=(−∂σ/∂T)*(∂T/∂x)

in which (∂t/∂x) is the temperature gradient. From this, it is understood that the temperature gradient must be increased in order to quickly carry out the domain wall displacement.

Meanwhile, in carrying out reproduction from the magneto-optical disc on the basis of the domain wall displacement detection, as the magneto-optical disc moves in the direction of the arrow 90, the domain wall 87 quickly is displaced to the highest temperature portion also when the domain wall 87 comes to a rear end 91 of the isothermal area. This domain wall displacement at the rear end part 91 is called ghost.

To restrain the effect of the ghost generated at the rear end part, it is necessary to reduce the driving force F(x) of the domain wall displacement at the rear end part 91 and bring the domain wall displacement away from the reproduction field.

Thus, in the second embodiment, at the time of reproduction, the intensity of the laser beam is switched on the DWDD disc so that the temperature gradient in the beam traveling direction is raised to increase the driving force F(x) of the domain wall displacement at the front end part, which contributes to reproduction, while the gradient at the rear end part is lowered to restrain the generation of the ghost and reduce its effect. At the time of recording, such switching of the intensity distribution of the laser beam is not carried out because it lowers the writing efficiency.

The detailed structure and operation of the magneto-optical disc recording/reproducing device will now be described. In FIG. 10, the optical system of the optical pickup device 62 has the following elements: a collimating lens 66 for transforming a laser beam emitted from the LD 67 to a collimated beam; a beam splitter 64 for splitting the collimated beam (laser beam) passed through the liquid crystal unit 65 of the optical spot shaping device; an objective lens 63 as an output end of the laser beam; a Wollaston prism 68; and a condenser lens 69. The irradiation path is made up of the collimating lens 66, the beam splitter 64 and the objective lens 63. The return light path is made up of the objective lens 63, the Wollaston prism 68 and the condenser lens 69.

The driving of the optical pickup device 62 will now be described. The objective lens 63 is supported to be movable in the tracking direction and the focusing direction by a biaxial driving circuit 75. Data on the magneto-optical disc 60 is read by moving the optical pickup device 62 in a radial direction of the magneto-optical disc 60. The optical pickup device 62 is supported by a tread mechanism, not shown, and is thus made-movable in the radial direction of the magneto-optical disc 60. A large shift of the reading position is made by this thread mechanism. As the objective 63 lens is moved in the radial direction of the magneto-optical disc 60 by the biaxial driving circuit 75 on the basis of a tracking servo operation, a small shift of the reading position is made. Moreover, as the objective lens 63 is moved in directions toward and away from the magneto-optical disc 60 by the biaxial driving circuit 75 on the basis of a focusing servo operation, the focusing of the laser beam on the signal recording surface of the magneto-optical disc 60 is controlled.

The emission of a laser beam and the return of the laser beam in the optical pickup device 62 having the above-described optical system will be described hereinafter. A diffused laser beam emitted from the LD 67 is transformed to a collimated beam by the collimating lens 66 and passes through the liquid crystal unit 65 and the beam splitter 64 of the light spot shaping device, which will be described later. After that, the laser beam is condensed by the objective lens and cast onto the magneto-optical disc 60. In this case, the objective lens 63 is moved in the tracking direction and the focusing direction by the biaxial driving circuit 75, as described above. The laser beam emitted from the optical pickup device 62 may be a laser beam for reproduction/recording. First, it is now assumed that a laser beam for reproduction is cast from the optical pickup device 62.

Return light reflected by the magneto-optical disc 60 becomes incident oil the beam splitter 64 via the objective lens 63. The beam splitter 64 leads the return light toward the Wollaston prism 68. The Wollaston prism 68 splits the return light from the magneto-optical disc 60 and casts the split light to the PD 70 via the condenser lens 69.

The ON/OFF operation and the output level of the laser beam output from the LD 67 of the optical pickup device 62 are controlled by a laser driving unit, not shown.

As the PD 70 of the optical pickup device 62, for example, a photodetector having two quadrisected light receiving areas is used. On the basis of a received light quantity signal detected by the PD 70, a matrix unit 72, which will be described later, acquires a magneto-optical signal MO (main) or the like.

Another structure and operation of the reproducing processing system including the above-described light spot shaping device, for processing a reproduced signal from the optical pickup device 62, will now be described. From each light receiving area of the PD 70 of the optical pickup device 62, a received light quantity signal is outputted, which is caused to be an electric signal corresponding to the quantity of the received return light from the magneto-optical disc 60. This received light quantity signal is supplied to an I-V converter 71. The I-V converter 71 carries out current/voltage conversion of the received light quantity signal. Each received light quantity signal caused to be an electric signal by the I-V converter 71 is supplied to the matrix unit 72.

The matrix unit 72 performs arithmetic processing on each received light quantity signal and thus generates a magneto-optical signal MO (main) corresponding to the data recorded on the magneto-optical disc 60. The matrix unit 72 also generates a focusing error signal FE and a tracking error signal TE. The matrix unit 72 also generates an RF signal.

The focusing error signal FE and the tracking error signal TE generated by the matrix unit 72 are supplied to a phase compensation circuit 74, which operates as a servo controller. The phase compensation circuit 74 generates a focusing driving signal based on the focusing error signal FE and a tracking drilling signal based on the tracking en or signal TE and applies these signals to a focusing coil and a tracking coil of the biaxial driving circuit 75. Thus, a servo system for causing the objective lens 63 to converge at a precise focal point with respect to the direction of the recording track is constituted.

In this magneto-optical disc recording/reproducing device, the read signal MO (main) from the magneto-optical disc, generated by the matrix unit 72, is supplied to a data detecting unit 78 and data is detected there on the basis of a reproducing clock, which will be described later.

The RF signal generated by the matrix unit 72 is supplied to a sector detecting unit 73 and a recording mark recorded for each sector is detected there. From the recording mark recorded for each sector, detected by the sector detecting unit 73, a timing generator 79 generates a clock signal having a predetermined frequency and supplies this clock signal to the data detecting unit 78 and the phase compensation liquid crystal driving circuit 76 of the light spot shaping device.

The structure and operation of the recording processing system will now be described. In the magneto-optical disc recording/reproducing device, when a write signal supplied by a host computer or the like, not shown, the encoder encodes the write signal and then supplies the encoded signal to a magnetic head 80 via a magnetic head driving circuit 77. The magnetic head 80 generates a magnetic field corresponding to the supplied write signal and applies this magnetic field to the magneto-optical disc 60. In this case, the optical pickup device 62 casts a recording laser beam via the objective lens 63 to the position on the magneto-optical disc 60 where the modulation magnetic field is applied by the magnetic head 80.

The structure and operation of the light spot shaping device in this magneto-optical disc recording/reproducing device will be described hereinafter. As described above, the light spot shaping device has the liquid crystal unit 65 provided in the irradiation path of the optical system of the optical pickup device 62 and having the split pattern electrode along the radial direction of the optical disc, and the phase compensation liquid crystal driving circuit 76 for controlling phase compensation in the liquid crystal unit 65.

The liquid crystal unit 65 has split pattern electrodes A, B, C, D and E, as shown in FIG. 3. The phase compensation liquid crystal driving circuit 76 changes a voltage to be applied to the split pattern electrodes A, B, C, D and E and thus provides aberration to a reproducing laser beam so as to shape a light spot on the magneto-optical disc into a linear direction.

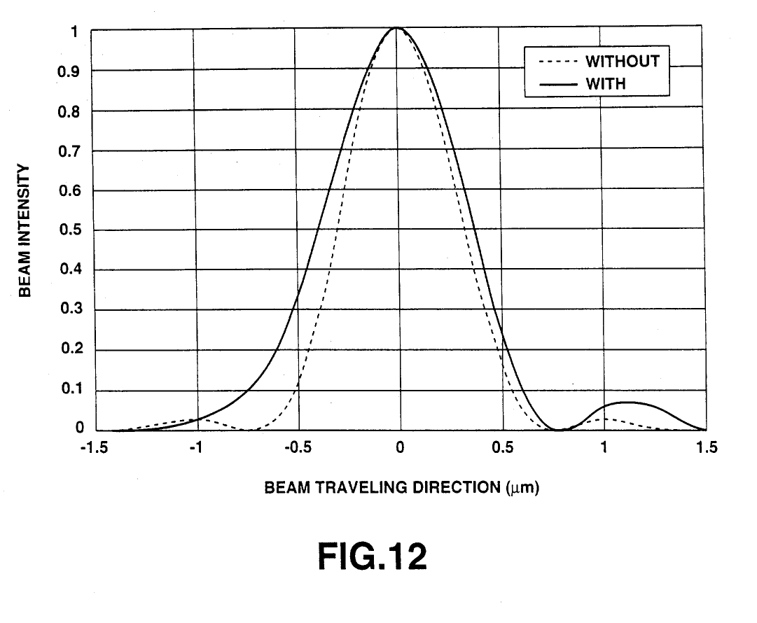

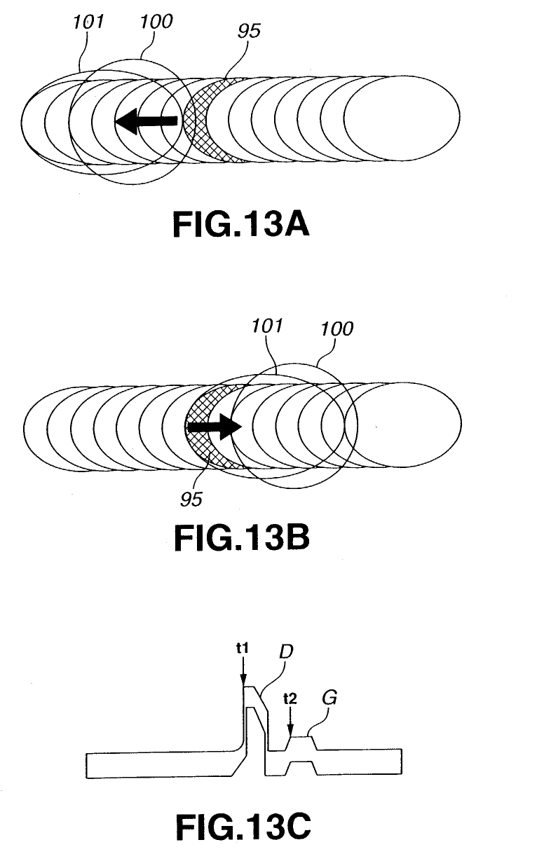

The basic principle of the operation of the second embodiment in the case where the present invention is applied to a DWDD disc is already described with reference to FIG. 11. The above-described principle will now be described in detail with reference to FIGS. 12 and 13.

Referring to FIG. 13, front end enlargement and rear end enlargement of a domain wall of an isolation mark 95 in an isothermal area 101 will be described first. In FIG. 13A, in the isothermal area 101 of a beam spot 100 with respect to the isolation mark 95, front end enlargement due to domain wall displacement of the isolation mark 95 at a front end part is generated at a time t1. By this front end enlargement generated at the time t1, a data signal D is acquired as shown in FIG. 13C. However, at a time t2, which is delayed from the front end enlargement start time t1 by (isothermal area length d÷linear velocity V1), rear end enlargement due to domain wall displacement of the isolation mark 95 at a rear end part is generated as shown in FIG. 13B. Therefore, a read signal (MO signal) based on the domain wall displacement detection contains, in addition to the data signal D, a ghost signal G which has the same signal length as the data signal D and a lower level than the data signal D and is delayed from tie data signal D by the above-described amount d/V1. The read signal is a signal such that the levels of both the data signal D and the ghost signal G are superimposed.

In the DWDD disc, the driving force F(x) of the domain wall displacement at the front end part, which contributes to reproduction, is proportional to the slope of temperature distribution in a beam traveling direction indicated by an arrow 90, as shown in FIG. 11. From this, it is understood that the temperature gradient must be increased in order to quickly carry out the domain wall displacement. Thus, the positive side in the beam traveling direction, that is, on the front end enlargement side, the slope of a characteristic with compensation indicated by a solid line can be made steep, as shown in FIG. 12.

In carrying out reproduction from the magneto-optical disc on the basis of the domain wall displacement detection, in order to restrain the effect of the ghost generated at the time t2, it is necessary to reduce the driving force F(x) of the domain wall displacement at the rear end part and bring the domain wall displacement away from the reproduction field, as shown in FIG. 13B. Thus, on the negative side of the beam traveling direction, that is, on the real end enlargement side, the slope of the characteristic of the solid line can be gentler than a characteristic indicated by a broken line, as shown in FIG. 2.

That is, on the DWDD disc, at the time of reproduction, the intensity gradient in the beam traveling direction may be raised and the gradient at the rear end part may be made gentle to increase the driving force of the domain wall displacement at the front end pail, which contributes to reproduction, and also to restrain the generation of the ghost and reduce its effect.

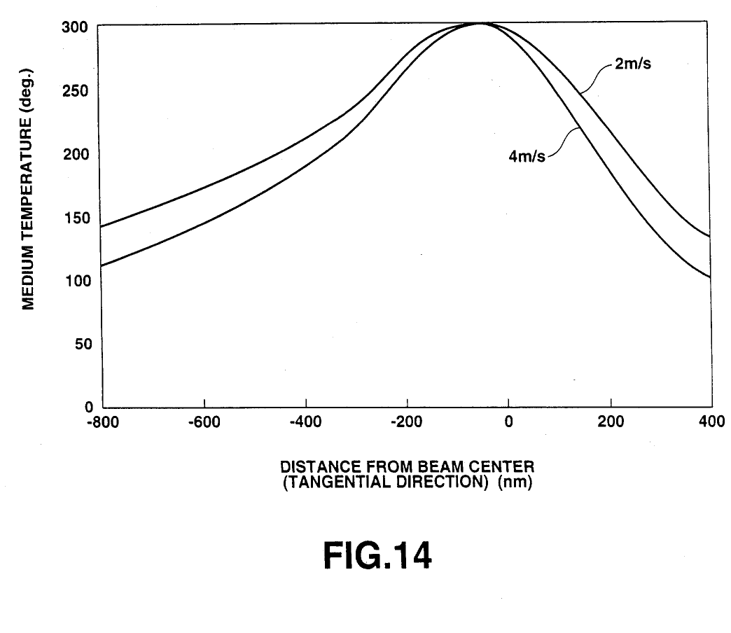

The phase compensation liquid crystal driving circuit 76 shown in FIG. 10 changes a voltage to be applied to the split pattern electrodes A, B, C, D and E of the liquid crystal unit 65 and provides aberration to the reproducing laser beam, thus shaping a light spot oil the magneto-optical disc into a linear direction. Specifically, coma correction is made under such correction conditions as +λ/10 for the electrodes A and D, −λ/10 for the electrodes B and E, and 0 for the electrode C, and the collection quantity is controlled. By doing so, the characteristic shown in FIG. 12 is acquired. Since the actual temperature profile of the spot on the magneto-optical disc due to irradiation with the light beam changes in accordance with the linear velocity and the temperature characteristic of the medium as shown in FIG. 14, the connection quantity is optimized at the initial stage. It is sequentially controlled in accordance with the optimization of the correction quantity of the beam intensity or the optimum correction quantity based on the linear velocity.

The beam intensity distribution as described above need not be corrected at the time of recording because it lowers the writing efficiency. Therefore, in the magneto-optical disc recording/reproducing device having the structure shown in FIG. 10, beam distribution is switched between recording and reproduction.

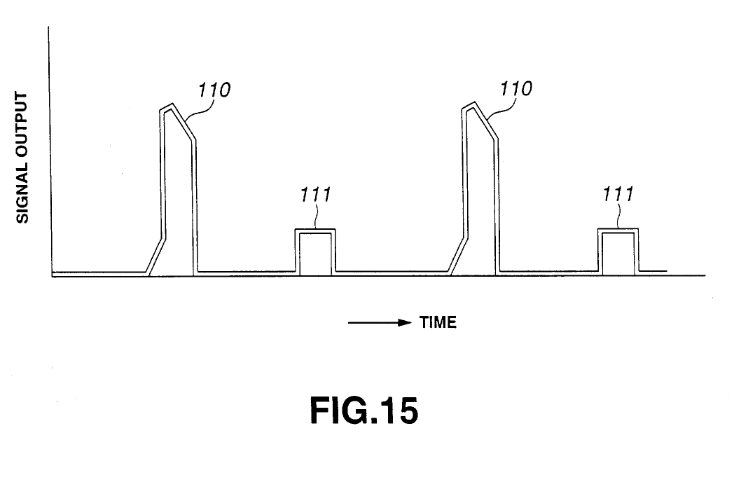

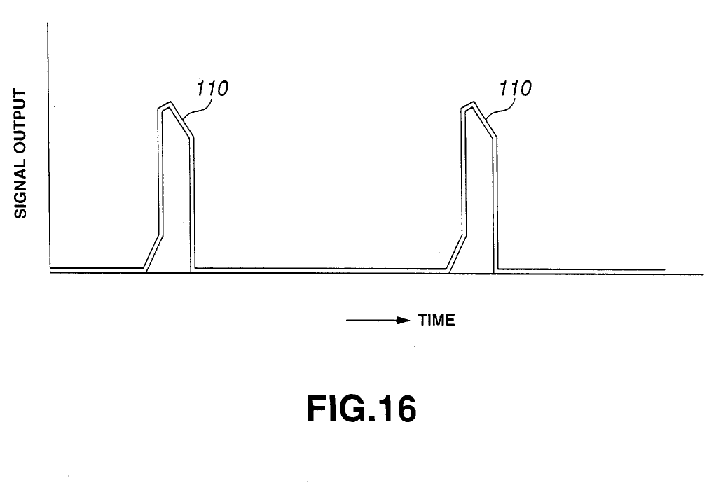

Thus, since the magneto-optical disc recording/reproducing device has the light spot shaping device provided in the optical pickup device 62, when reproducing a recorded signal from the magneto-optical disc (DWDD) 60, a ghost signal can be eliminated, which would be generated in addition to a data signal 110 by the conventional technique as shown in FIG. 15, and it is possible to provide the data signal 110 alone, as shown in FIG. 16.

As described above, in the magneto-optical disc recording/reproducing device shown in FIG. 10, a reproducing laser beam can be cast onto a magneto-optical disc while changing the shape of a spot from a single optical pickup device, thus eliminating a ghost signal and reproducing a data signal with high quality. Moreover, by casting a recording laser beam without changing the spot shape, the writing efficiency at the time of recording can be prevented from lowering.

### INDUSTRIAL APPLICABILITY

In the light spot shaping device and method according to the present invention, a voltage to be applied to the split pattern electrode of the liquid crystal means is changed in accordance with the type of medium and thus changing the optical characteristic of the spot of light cast onto a plurality of types of removable media from the same light source via the same optical path. Therefore, optimum light spots for the plurality of different media can be shaped.

Moreover, in the light spot shaping device and method according to the present invention, a voltage to be applied to the split pattern electrode of the liquid crystal means is changed at the time of recording and/or reproduction and thus changing the optical characteristic of the light spot. Therefore, recording light and/or reproducing light can be cast onto an optical disc while changing the shape of the spot from a single optical pickup device.

The optical pickup device according to the present invention has the liquid crystal means provided in the optical system and having the split pattern electrode formed along a radial direction of an optical disc, and the light spot shaping means for changing a voltage to be applied to the split pattern electrode of the liquid crystal means for the type of the optical disc and thus changing the optical characteristic of the light spot. Therefore, light spots adapted to a plurality of optical discs having at least different track pitches can be cast thereon.

Moreover, the optical pickup device according to the present invention has the liquid crystal means provided in the optical system and having the split pattern electrode formed along a radial direction of an optical disc, and the light spot shaping means for changing the optical characteristic of the light spot between when casting a recording light and when casting a reproducing light. Therefore, the recording light and/or the reproducing light can be cast onto the optical disc while changing the shape of the spot.

The optical disc device according to the present invention has the liquid crystal means provided in the optical system and having the split pattern electrode foiled along a radial direction of an optical disc, and the light spot shaping means for changing a voltage to be applied to the split pattern electrode of the liquid crystal means for the type of the optical disc and thus changing the optical characteristic of the light spot. Therefore, light spots adapted to a plurality of types of optical discs having at least different track pitches can be formed on the respective optical discs and information signals can be reproduced from the respective optical discs.

Moreover, the optical disc device according to the present invention has the liquid crystal means provided in the optical system and having the split pattern electrode formed along a radial direction of an optical disc, and the light spot shaping means for changing the optical characteristic of the light spot between when casting a recording light and when casting a reproducing light. Therefore, the laser beam for recording/reproduction can be cast onto the optical disc while changing the shape of the spot.

1. A light spot shaping device for shaping a spot of light cast onto a plurality of types of removable media from the same light source through the same optical path, in accordance with the type of the medium, the device comprising:
liquid crystal means having a split pattern electrode formed along the direction of a recording track of the medium; and
control means for changing a voltage to be applied to the split pattern electrode of the liquid crystal means in accordance with the type of the medium and thus changing the optical characteristic of the light spot.

2. The light spot shaping device as claimed in claim 1, wherein the control means changes the voltage to be applied to the split pattern electrode of the liquid crystal means in accordance with the type of the medium, thereby providing aberration to the light at least along the direction of the track.

3. The light spot shaping device as claimed in claim 1, wherein the plurality of types of removable media are a plurality of types of removable optical discs having at least different track pitches.

4. A light spot shaping method for shaping a spot of light cast onto a plurality of types of removable media from the same light source through the same optical path, in accordance with the type of the medium, the method comprising
a control step of providing liquid crystal means having a split pattern electrode formed along the direction of a recording track of the medium and changing a voltage to be applied to the split pattern electrode of the liquid crystal means in accordance with the type of the medium, thus changing the optical characteristic of the light spot.

5. The light spot shaping method as claimed in claim 4, wherein at the control step, the voltage to be applied to the split pattern electrode of the liquid crystal means is changed in accordance with the type of the medium, thereby providing aberration to the light at least along the direction of the track.

6. The light spot shaping method as claimed in claim 4, wherein the plurality of types of removable media are a plurality of types of removable optical discs having at least different track pitches.

7. A light spot shaping device for separately shaping an incident laser beam in recording and in reproduction to a spot of light cast onto a medium for recording and/or reproducing an information signal, the device comprising:
liquid crystal means having a split pattern electrode formed along the direction of a recording track of the medium; and
control means for changing a voltage to be applied to the split pattern electrode of the liquid crystal means between the recording and the reproduction and thus changing the optical characteristic of the light spot.

8. The light spot shaping device as claimed in claim 7, wherein the control means changes the voltage to be applied to the split pattern electrode of the liquid crystal means when the information signal from the medium, thus providing aberration to the light incident on the liquid crystal means along the direction of the recording track of the medium so as to change the optical characteristic of the light spot.

9. The light spot shaping device as claimed in claim 7, wherein the control means stops the application of the voltage to the split pattern electrode of the liquid crystal means when recording an information signal to the medium and thus does not provide aberration to the light incident on the liquid crystal means.

10. The light spot shaping device as claimed in claim 7, wherein the medium is an optical disc from which a recorded signal is reproduced by magnetic enlargement due to a domain wall displacement phenomenon.

11. A light spot shaping method for separately shaping an incident laser beam in recording and in reproduction to a spot of light cast onto a medium for recording and/or reproducing an information signal, the method comprising
a control step of providing liquid crystal means having a split pattern electrode formed along the direction of a recording track of the medium and changing a voltage to be applied to the split pattern electrode of the liquid crystal means between the recording and the reproduction, thus changing the optical characteristic of the light spot.

12. The light spot shaping method as claimed in claim 11, wherein at the control step, the voltage to be applied to the split pattern electrode is changed when reproducing the information signal from the medium, thus providing aberration to the light incident on the liquid crystal means along the direction of the recording track of the medium so as to change the optical characteristic of the light spot.

13. The light spot shaping method as claimed in claim 11, wherein at the control step, the application of the voltage to the split pattern electrode of the liquid crystal means is stopped when recording an information signal to the medium and aberration is not provided to the light incident on the liquid crystal means.

14. The light spot shaping method as claimed in claim 11 wherein the medium is an optical disc from which a recorded signal is reproduced by magnetic enlargement due to a domain wall displacement phenomenon.

15. An optical pickup device for forming a spot of light adapted to a plurality of types of removable optical discs having at least different track pitches, onto the optical disc, thus reading an information signal, the device comprising:
a light source for emitting light;
an optical system for casting the light emitted from the light source onto a signal recording surface of the optical disc and passing return light reflected by the signal recording surface of the optical disc;
photodetection means for detecting the return light passed by the optical system;
liquid crystal means provided in the optical system and having a split pattern electrode stacked in a radial direction of the optical disc; and
light spot shaping means for changing a voltage to be applied to the split pattern electrode of the liquid crystal means for each type of the optical disc and thus changing the optical characteristic of the light spot.

16. The optical pickup device as claimed in claim 15, wherein the light spot shaping means changes the voltage to be applied to the split pattern electrode of the liquid crystal means in accordance with each type of the optical disc, thus providing aberration to the light at least along the radial direction.

17. The optical pickup device as claimed in claim 16, wherein light spots adapted to a first optical disc with a track pitch of 1.6 μm and groove recording, a second optical disc with a track pitch of 0.95 μm and land recording, and a third optical disc with a track pitch of not more than 0.70 μm and land and groove recording, are shaped by the light spot shaping means.

18. The optical pickup device as claimed in claim 17, wherein with respect to the first optical disc, the light spot shaping means changes the voltage to be applied to the split pattern electrode of the liquid crystal means and thus provides astigmatism in the radial direction of the optical disc to the light incident on the liquid crystal means.

19. The optical pickup device as claimed in claim 17, wherein with respect to the second optical disc, the light spot shaping means changes the voltage to be applied to the split pattern electrode of the liquid crystal means and thus provides coma in the radial direction of the optical disc to the light incident on the liquid crystal means.

20. The optical pickup device as claimed in claim 17, wherein with respect to the third optical disc, the light spot shaping means changes the voltage to be applied to the split pattern electrode of the liquid crystal means and thus provides astigmatism in the radial direction of the optical disc to the light incident on the liquid crystal means and defocuses the light spot.

21. The optical pickup device as claimed in claim 20, wherein a recorded signal is reproduced from the third optical disc by magnetic enlargement due to a domain wall displacement phenomenon.

22. An optical pickup device for casting recording light and/or reproducing light for recording and/or reproducing an information signal to an optical disc, the device comprising:
a light source for emitting light;
an optical system for casting the light emitted from the light source onto a signal recording surface of the optical disc and passing return light reflected by the signal recording surface of the optical disc;
photodetection means for detecting the return light passed by the optical system;
liquid crystal means provided in the optical system and having a split pattern electrode stacked in a radial direction of the optical disc; and
light spot shaping means for changing the optical characteristic of the light spot between when casting the recording light and when casting the reproducing light.

23. The optical pickup device as claimed in claim 22, wherein the light spot shaping means changes the voltage to be applied to the split pattern electrode of the liquid crystal means when reproducing the information signal from the optical disc, thus providing aberration to the light incident on the liquid crystal means along a tangential direction of a track of the optical disc.

24. The optical pickup device as claimed in claim 22, wherein the light spot shaping means stops the application of the voltage to the split pattern electrode of the liquid crystal means in a recording mode for recording an information signal to the optical disc and does not provide aberration to the light incident on the liquid crystal means.

25. The optical pickup device as claimed in claim 22, wherein a recorded signal is reproduced from the optical disc by magnetic enlargement due to a domain wall displacement phenomenon.

26. An optical disc device having a reproducing part for forming a spot of light adapted to a plurality of types of removable optical discs having at least different track pitches, onto the optical disc, thus reading an information signal from each optical disc,
the reproducing part comprising:
a light source for emitting light;
an optical system for casting the light emitted from the light source onto a signal recording surface of the optical disc and passing return light reflected by the signal recording surface of the optical disc;
photodetection means for detecting the return light passed by the optical system;
liquid crystal means provided in the optical system and having a split pattern electrode formed along a radial direction of the optical disc; and
light spot shaping means for changing a voltage to be applied to the split pattern electrode of the liquid crystal means in accordance with the type of the optical disc and thus changing the optical characteristic of the light spot;
the optical disc device reproducing the information signal on the basis of the quantity of the return light detected by the photodetection means.

27. The optical disc device as claimed in claim 26, wherein the light spot shaping means changes the voltage to be applied to the split pattern electrode of the liquid crystal means in accordance with each type of the optical disc, thus providing aberration to the light at least along the radial direction.

28. The optical disc device as claimed in claim 27, wherein light spots adapted to a first optical disc with a track pitch of 1.6 μm and groove recording, a second optical disc with a track pitch of 0.95 μm and land recording, and a third optical disc with a track pitch of not more than 0.70 μm and land and groove recording, are shaped by the light spot shaping means.

29. The optical disc device as claimed in claim 28, wherein with respect to the first optical disc, the light spot shaping means changes the voltage to be applied to the split pattern electrode of the liquid crystal means and thus provides astigmatism in the radial direction of the optical disc to the light incident on the liquid crystal means.

30. The optical disc device as claimed in claim 28, wherein with respect to the second optical disc, the light spot shaping means changes the voltage to be applied to the split pattern electrode of the liquid crystal means and thus provides coma in the radial direction of the optical disc to the light incident on the liquid crystal means.

31. The optical disc device as claimed in claim 28, wherein with respect to the third optical disc, the light spot shaping means changes the voltage to be applied to the split pattern electrode of the liquid crystal means and thus provides astigmatism in the radial direction of the optical disc to the light incident on the liquid crystal means and defocuses the light spot.

32. The optical disc device as claimed in claim 31, wherein a recorded signal is reproduced from the third optical disc by magnetic enlargement due to a domain wall displacement phenomenon.

33. An optical disc device for casting recording light and/or reproducing light to an optical disc so as to record and/or reproduce an information signal, the device comprising:
a light source for emitting light;
an optical system for casting the light emitted from the light source onto a signal recording surface of the optical disc and passing return light reflected by the signal recording surface of the optical disc;
photodetection means for detecting the return light passed by the optical system;
liquid crystal means provided in the optical system and having a split pattern electrode stacked in a radial direction of the optical disc; and
light spot shaping means for changing the optical characteristic of the light spot between when casting the recording light and when casting the reproducing light.

34. The optical disc device as claimed in claim 33, wherein the light spot shaping means changes the voltage to be applied to the split pattern electrode of the liquid crystal means when reproducing the information signal from the optical disc, thus providing aberration to the light incident on the liquid crystal means along a tangential direction of a track of the optical disc.

35. The optical disc device as claimed in claim 33, wherein the light spot shaping means stops the application of the voltage to the split pattern electrode of the liquid crystal means when recording an information signal to the optical disc and does not provide aberration to the light incident on the liquid crystal means.

36. The optical disc device as claimed in claim 34, wherein a recorded signal is reproduced from the optical disc by magnetic enlargement due to a domain wall displacement phenomenon.
